(19) United States
(12) Patent Application Publication
(10) Pub. No.: US 2010/0008708 A1
(43) Pub. Date: Jan. 14, 2010

(54) SEPARATE PATHS FOR MEDIA TO A MAIN STACKER

(75) Inventors: NICHOLAS W. CZEBINIAK, WILLIAMSON, NY (US); GREGORY D. GERBASI, WEBSTER, NY (US); JEFFREY M. GRAMOWSKI, NORTH CHILI, NY (US); WILLIAM D. MILILLO, ONTARIO, NY (US); ARTHUR H. KAHN, COHOCTON, NY (US)

Correspondence Address: JAMES J. RALABATE, 5792 MAIN ST., WILLIAMSVILLE, NY, 14221, US

(73) Assignee: XEROX CORPORATION, NORWALK, CT (US)

(21) Appl. No.: 12/170,711

(22) Filed: Jul. 10, 2008

(51) Int. Cl. G03G 15/00

(52) U.S. Cl. 399/361; 399/410

(57) ABSTRACT

This is a marking system, either electrostatic or non-electrostatic marking system that directs both single and sets of media to a common stacker. This invention provides a way or path 1 to send media sheets directly to the stacker without going through the compiler. Compiling stations do not stack unfinished sheets well. An additional media path 2 is added to send sheets directly to the compiler for making into sets, and then to the stacker to be stacked with the single media sheets of path 1.

This invention relates to marking systems and, more specifically, to a system having separate paths for sheets to reach a main stacker.

### BACKGROUND

While the present invention can be effectively used in a plurality of paper handling or marking systems, it will be described for clarity as used in electrostatic marking systems such as electrophotography. In an electrostatographic reproducing apparatus commonly used today, a photoconductive insulating member may be charged to a negative potential, thereafter exposed to a light image of an original document to be reproduced. The exposure discharges the photoconductive insulating surface in exposed or background areas and creates an electrostatic latent image on the member which corresponds to the image areas contained within the original document. Subsequently, the electrostatic latent image on the photoconductive insulating surface is made visible by developing the image with a developing powder referred to in the art as toner. During development, the toner particles are attracted from the carrier particles by the charge pattern of the image areas on the photoconductive insulating area to form a powder image on the photoconductive insulating area to form a powder image on the photoconductive area. This image may be subsequently transferred or marked onto a support surface such as copy paper to which it may be permanently affixed by heating or by the application of pressure. Following transfer of the toner image or marking, the copy paper may be removed from the system by a user or may be automatically forwarded to a finishing station where the copies may be collected, compiled and stapled and formed into books, pamphlets or other sets.

As above noted, there are many marking systems that transport paper or other media after the paper is marked in marking step or steps. These marking systems could include electrostatic marking systems, non-electrostatic marking systems and printers or any other system where paper or other flexible media or receiving sheets are transported internally to an output device such as a finisher and compiler station or stations. These devices include those used for collecting or gathering printed sheets so they may be formed into sets such as books, pamphlets, forms, sales literature, instruction books and manuals and the like.

These electrostatic marking systems have finisher and compilers located at a site after the receiving media sheets (paper) have been marked with a toner. A finisher is generally defined as an output device that has various post printer functions or options such as hole punching, corner stapling, edge stapling, sheet and set stacking, letter or tri-folding, Z-folding, Bi-folding, signature booklet making, set binding (including thermal, tape and perfect binding), trimming, post process sheet insertion, saddle stitching and others. Media not going through a finisher will be described herein as “unfinished” sheets or media. In today's marketplace stacking and stitching finishers for cut sheet digital printers or marking systems typically do not exceed fast throughput rates because of system drawbacks. These rates are typically further reduced when handling both finished and unfinished media sheets. With the emphasis today on digital marking products capable of ever increasing throughput, the need for printing system or devices capable of handling both finished and unfinished media sheets at higher speeds for both stacking and stitching is important.

Today, there is no reliable cut sheet digital stacking and stitching finisher module that is capable of handling prints or rapid rates. As throughputs of marking systems become higher and higher, there will be a need for a module capable of handling finished and unfinished cut marked sheet substrates for efficient stacking, and at the same time not being large and bulky so as to take up valuable space in the marking system. Also, a module capable of effectively handling stacking of both stapled and non-stapled prints in one stacker would enhance the versatility and adaptability of such a module.

Numerous types of sheet stacking trays are known in the highly developed printing art over many years. The following Xerox Corporation U.S. patent disclosures are noted and incorporated by reference by way of background and for appropriate alternative or additional details: U.S. Pat. Nos. 5,685,529; 5,915,687; 5,261,655; 5,045,881; 5,318,401, 5,098,074 and other art cited therein. The disclosures of these Xerox patents are incorporated by reference into this disclosure.

The term “reproduction apparatus” “marking system”, or “printer” as used herein broadly encompasses various printers, copiers or multifunction machines or systems, xerographic or otherwise. The term “sheet” herein refers to a usually flimsy physical sheet of paper, plastic or other suitable physical print media substrate for images whether precut or web fed. The term “sheet stacking tray” broadly encompasses various sheet stacking bins or drawers unless indicated otherwise. A “print job” is normally a set of related such sheets, usually one or more collated or other sets copied from a set of original document sheets or electronic document page images from a particular user, or for a particular customer or otherwise related. The term “stapler” as used through this disclosure includes any finishing item.

### SUMMARY

It is known in the prior art stacking systems that compiling stations do not stack unfinished sheets well. In the present embodiments, at least two paper paths are provided that send sheets to a single stacker. In a first path the sheets are sent to a compiler station where the set is compiled and stapling or other finishing is applied. The finished set is then ejected (in one embodiment) via a horizontal transport to the main stacker. In a second path, unfinished sheets are sent in one path directly to the stacker without going through the compiler. The stacker contains side tampers and a trail edge tamper that applies to both stapled and unstapled sheet/sets.

Thus, embodiments of this invention provide a finisher architecture having two distinct paths for sheets to take to reach the main stacker tray. A first path provides set-wise compiling and finishing of sheets. Sheets directed to the first path would be deposited into the main stacker as sets via a suitable set transport and could include side and process direction tamping. Sheets directed to the second path would be individually placed on to the top of each stack via a separate sheet transport, such as a vacuum transport. They could also be subject to side and process direction tamping. This architecture can provide stacking of both sets and individual sheets with excellent registration.

There are situations where both finished and unfinished media are required on the same job; for example, a blue sheet that precedes a set may indicate it's Mary's copies; a red sheet that precedes a set may indicate John's copies, etc. Also, separator sheets may be desirable for various reasons such as different chapters, etc. Sometimes, subsets may be differentiated or indicated by a single sheet.

The digital front end (DFE) 22 sends to the controller or scheduler 4 among other functions will direct the paper or feeder, the direction of the paper to a compiler or the main stacker, the opening and closing of decision gates to direct the paper to path 1 or path 2, the type of finishing to be accomplished at the compiler and other functions. Also sensors can be located before or along both paths to indicate when the media has entered the system, when media are exiting the compiler and when media are being deposited in the main stacker. Appropriate software is available today to include in the controller. The controller, therefore, is like the traffic cop directing media to either or both paths and ultimately to the stacker. Known controllers like those of the present invention are disclosed in U.S. Pat. Nos. 4,144,550; 4,158,500; 4,176,945, 4,179,215; 4,229,101; and 4,475,156. These disclosures are incorporated by reference into the present disclosure.

Deflector gates or decision gates are also known as described in U.S. Pat. No. 5,045,881 and U.S. Pat. No. 5,261,655 which are incorporated by reference into the present disclosure.

Sensors 18 of the type used in the present invention are disclosed in U.S. Pat. No. 5,261,655 which is incorporated by reference into the present disclosure.

In one embodiment, when the controller determines as preset that a given number like ten media copies have been stapled, then it releases one (or whatever is preprogrammed) unfinished sheet to send to the stacker to accompany the sheet of ten finished sheets where all sheets are stacked. The stacker contains side tampers and a trail edge tamper that applies to both stapled and unstapled sheets for a well aligned-stack.

### BRIEF DESCRIPTION OF THE DRAWINGS

FIG. 1A illustrates the entire flow chart of an embodiment of a system or module of this invention.

FIG. 1B illustrates a paper path flow of an embodiment of a module of this invention.

FIG. 2 illustrates a typical decision gate(s) useful in the present invention.

### DETAILED DISCUSSION OF DRAWINGS AND PREFERRED EMBODIMENTS

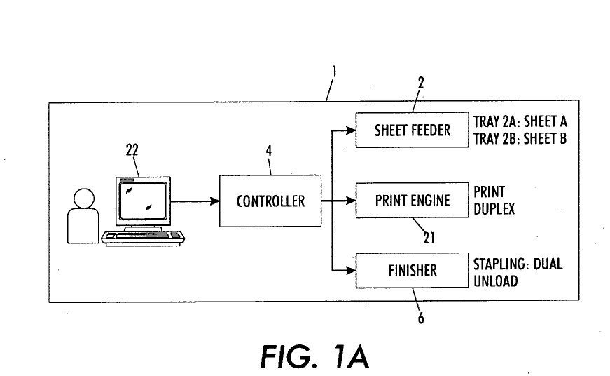

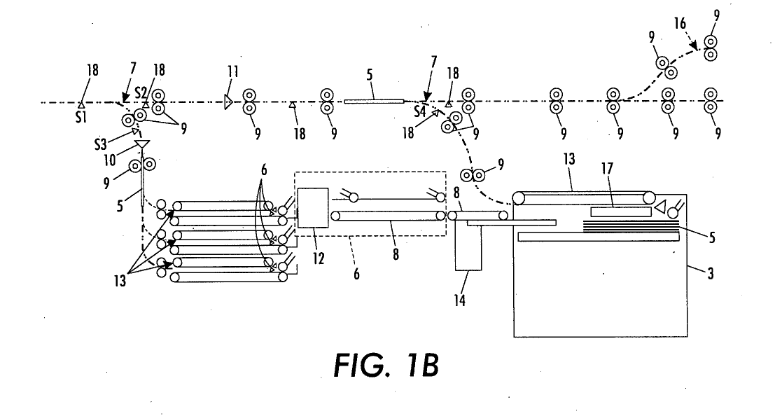

In FIGS. 1A and 1B the entire flow chart of the transfer module 1 extends from media feeding at digital front end (DFE) feeder 22 all the way to final destination stacker 3. The user information input converts to raw data to be sent to controller 4. The controller 4 tells each module, like the feeder 2, print engine 21, and finisher 6, what to do. As an example, feeder 2 needs sheet A to come from tray 2A and sheets 2-30 from tray 2B, or the controller 4 tells the print engine 21 to print in duplex. It tells the finisher 6 that sheet A is unfinished and sheets B (or 2-30) require a dual staple and to unload all sheets when Job A is completed Since the system of module 1 is schedule driven, the software of the controller 4 knows whether the next sheet 5 coming into the finisher 6 requires finishing or not. If the first sheet 5 is an admin sheet, for example, the software will move the decision gate so the sheet is sent directly to the main stacker 3. If the next set of sheets 5 requires finishing, then the diverter gate 7 will be switched to send the sheets to the compiler via a transport 13 where the sheets 5 are compiled and finished 6 before the set is ejected across a horizontal transport 8 and sent to the main stacker 3 where trail edge tamper 14 pushes the set against a registration wall of the stacker 3. The side tampers 17 will provide side-to-side registration of all media. An advantage of this invention is that when the customer only runs unfinished jobs, the stack quality will be substantially better than prior art systems. When the customer only sends finished jobs, then the present system is capable of handling the complete media range for finishing before the set is ejected to the main stacker 3. The arrows 10 show the paper 5 traveling to the compiler finisher 6 and the arrows 11 show the paper 5 travel directly to stacker 3. The stitching station 12 moves up and down to grab sets from the compiler 6 that are waiting for stitching. All of this progression is controlled by controller 4. A trail edge tamper 14 is used for finished sets only. However, the stacker 3 also contains side tampers 17. If single sheets are to be sent downstream to another finishing device, then an accommodation is made at sheet exit 16. The feeder 2 can be prints from an electrostatic printer or non-electrostatic printer 21. Sensors 18 may be located throughout the system and are in contact with the controller 4 for both input and output.

In the embodiment of FIGS. 1A and 1B, a job A is outlined tracing each page or sheet as it passes through the system 1. As noted in FIG. 1 description, since the system is schedule driven, the software (SW) knows whether the next sheet 5 coming into the finisher 6 requires finishing or not. If the first sheet 5 is an admin sheet, for example, the software will move the decision gates 7 so the sheet 5 is sent directly to the main stacker 3. If the next set of sheets requires finishing, then the diverter gate 7 will be switched to send the sheets to the compiler 6 where the sheets 5 are compiled and finished before the set is ejected across a horizontal transport and sent to the main stacker 3 where the trail edge tamper pushes the set against the registration wall. The side tampers 17 will provide side-to-side registration.

Job A in one embodiment illustrated in FIGS. 1A and 1B comprises the following pages and sets: S designates a sensor(s) and D designates a direction. Banner Page, Set 1, Slipsheet, Set 2, Slipsheet, Set 3, Slipsheet, Error Page, Admin. Page. S1-S4 are sensors 18 located at various system locations. D1 and D2 are directions 10 and 11 respectively.
Banner Page passes through S1→D1→S2→D2→S4→Main Stacker 3
Set 1 which requires stapling passes through S1→D1→S3→→→Main Stacker
Slipsheet passes through S1→D1→S2→S4÷Main Stacker 3
Set 2 which requires stapling passes through S1→D1→S3→→→Main Stacker
Slipsheet passes through S1→D1→S2→D2→S4→Main Stacker 3
Set 3 which requires stapling passes through S1→D1→S3→→→Main Stacker 3
Error Page passes through S1→D1→S2→D2→S4→Main Stacker 3
Admin Page passes through S1→D1→S2→D2→S4→Main Stacker 3

The advantage of this concept, as earlier noted, is that when the customer only runs unfinished jobs, the stack quality will be better than prior art systems. When the customer only sends finished jobs, then the compiler 6 is capable of handling the complete media range for finishing before the set is ejected to the main stacker. Finishing devices are typically catered to handle either unfinished or finished outputs. This device of FIG. 3 handles both. This is important to the customer because there are many different types of job submissions: VIPP (Variable Intelligent PostScript Printware), IPDS (Intelligent Printer Data Stream), LCDS (Line Controlled Data Stream), Digital Front End (DFE)—FreeFlow™ DocuSP®, Print Drivers. With all of these different types of job submission capabilities, the finishing device needs to handle the various types of requests coming from the user-submitter.

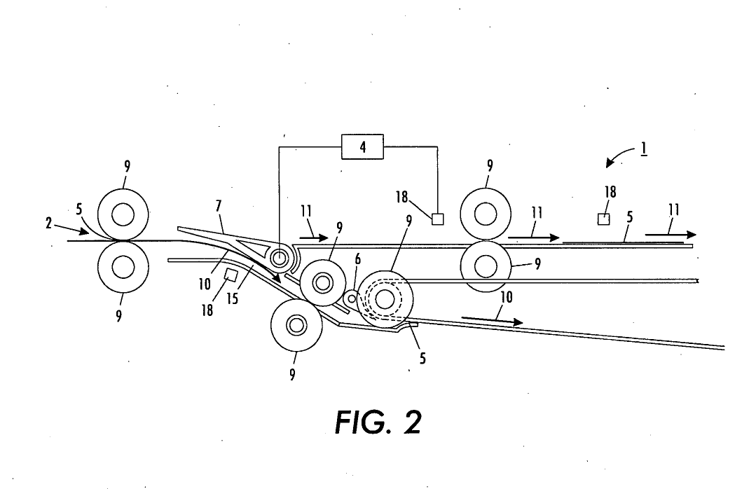

In FIG. 2, a close up view of an embodiment of decision or diverter gate(s) 7 is shown where feeder 2 feeds paper sheets 5 that are diverted by gate 7 to either the path 10 to the compiler-finisher or the path 11 going directly to stacker 3 as shown by arrows 10 and 11, respectively. The printed media comes from a printer and is fed to module 1 by feeder 2 which can be a DFE or other suitable feeder 2. If gate 7 is in the up position (as shown in FIG. 2) the paper media goes into conduit 15 on its way to a finisher-compiler 6 as shown by arrow 10. If the gate 7 is down, the paper sheet 5 goes over gate 7 and follows arrows 11 directly to stacker 3. The deflector gate 7 moves to deflect simple sheets 5 in a path 11 directly to stacker 3 and upward to direct the sheets 5 to a path 10 leading to a finisher or compiler station 6. Deflector gate 7 moves downward to direct sheets 5 to path 11 and upward to direct sheets 5 to conduit 15 and to finisher or stapler 12.

In summary, embodiments of the present invention provide a marking system, either electrostatic or non-electrostatic, for generating printed sheets and sets comprising a sheet feeder, a controller, a sheet finishing-compiler station, a movable diverter gate or gates, a main stacker, and at least two paper paths extending from said gate to said stacker. The gate is configured to divert a printed media to either a first or to a second of the paper paths. The first paper path leads to the finishing-compiling station to enable media to pass to a stapler in the compiler station for compiling into media sets before going to the main stacker. The second paper path is configured to pass unfinished single media sheets directly to the main stacker to be stacked with the sets. The gate when in an upward position directs the printed media to the finisher to form media sets, whereas when in a downward position directs the printed media directly to the stacker. The sets, after being stapled, are enabled to move to a horizontal transport and then to the stacker. The single media sheets are enabled when transported to the stacker to be registered directly on said media sets. The media sets and the single media sheets are enabled to be stacked during a same job run. The stacker comprises side tampers and a trail edge tamper that applies to both stapled sets and unstapled sheets. Both the finishing station and the stacker comprise tampers. As noted, the marking system can be an electrostatic marking system or a non-electrostatic marking system. The system contains a plurality of sensors that are located along the system which are in communication with the controller to supply type and location input to the controller.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A marking system for generating printed sheets and sets, said system comprising:
a sheet feeder, a controller,
a sheet finishing-compiler station,
a movable diverter gate or gates,
a main stacker, and at least two paper paths extending from said gate to said stacker;
said gate configured to divert a printed media to either a first or to a second of said paper paths;
said first paper path leading to said finishing-compiling station to enable said media to pass to a stapler in said compiler station for compiling into media sets before going to said main stacker;
said second paper path configured to pass unfinished single media sheets directly to said main stacker to be stacked with said sets.

2. The marking system of claim 1 wherein said gate when in an upward position directs said printed media to said finisher to form said sets.

3. The marking system of claim 1 wherein said gate when in a downward position directs said printed media directly to said stacker.

4. The marking system of claim 1 wherein said sets after stapled are enabled to move to a horizontal transport and then to said stacker.

5. The marking system of claim 1 wherein said single media sheets are enabled when transported to said stacker to be registered directly on said media sets.

6. The marking system of claim 1 wherein said media sets and said single media sheets are enabled to be stacked during a same job run.

7. The marking system of claim 1 wherein said stacker comprises side tampers and a trail edge tamper that applies to both stapled sets and unstapled sheets.

8. The marking system of claim 1 wherein said finishing station and said stacker both comprise tampers.

9. The marking system of claim 1 where it is an electrostatic marking system.

10. An electrostatic marking system for generating both single printed sheets and printed sheets sets, said system comprising:
a sheet feeder, a controller,
a sheet finishing-compiler station,
a movable diverter gate or gates,
a main stacker, and at least two paper paths extending from said gate to said stacker;
said gate configured to divert a printed paper or media to either a first or to a second of said paper paths;
said first paper path leading to said finishing-compiler stations, to enable said media to pass to a stapler in said finishing-compiler station for compiling into media sets before going to said main stacker;
said second paper path configured to pass unfinished single media sheets directly to said main stacker to be stacked with said sets or to exit from said system.

11. The marking system of claim 10 wherein said gate when in an upward position directs said printed media to said finisher to form said sets.

12. The marking system of claim 10 wherein said gate when in a downward position directs said printed media directly to said stacker.

13. The marking system of claim 10 wherein said sets after stapled are enabled to move to a horizontal transport and then to said stacker.

14. The marking system of claim 10 wherein said single media sheets are enabled when transported to said stacker to be registered directly on said media sets.

15. The marking system of claim 10 wherein said media sets and said single media sheets and said sets are enabled to be stacked during a same job run.

16. The marking system of claim 10 wherein said stacker comprises side tampers and a trail edge tamper that applies to both stapled sets and unstapled sheets.

17. The marking system of claim 1 wherein said finishing station and said stacker both comprise tampers.

18. The system of claim 10 where a plurality of sensors are located along said system, said sensors in communication with said controller to supply media location input to said controller.
